(19) United States
(12) Patent Application Publication
(10) Pub. No.: US 2008/0158231 A1
(43) Pub. Date: Jul. 3, 2008

(54) APPARATUS AND METHOD FOR MANAGING MUSIC FILES

(75) Inventors: Eun-jung LEE, Suwon-si (KR); Young-wan Seo, Suwon-si (KR); In-sik Myung, Incheon (KR); KiranPal Sagoo, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd, Suwon-si (KR)

(21) Appl. No.: 11/837,758

(22) Filed: Aug. 13, 2007

(30) Foreign Application Priority Data
Dec. 28, 2006 (KR) 2006-136761

(51) Int. Cl. G06T 13/00

(52) U.S. Cl. 345/473

(57) ABSTRACT

An apparatus and method for managing a music file including an extracting of characteristics of the music file and a generating of an animation corresponding to the music file and based on the characteristics is disclosed. The apparatus includes an information-extracting unit that extracts basic information from a predetermined music file, a characteristic-checking unit that checks characteristics of the music file, a table-generation unit that generates a table in which the extracted basic information and the checked characteristics are mapped to each of the animation elements of the animation, and a communication unit that transmits the generated table and a predetermined music file to an animation generation device.

### CROSS-REFERENCE TO RELATED APPLICATION

This application claims the benefit of Korean Application No. 2006-136761 filed on Dec. 28, 2006 in the Korean Intellectual Property Office, the disclosure of which is incorporated herein by reference.

### BACKGROUND OF THE INVENTION

1. Field of the Invention

Aspects of the present invention relate to managing a music file, and more particularly, to an apparatus and method for extracting characteristics of a music file, and generating and providing animation corresponding to the music file based on the extracted characteristics.

2. Description of the Related Art

Along with an increase of music-dedicated digital devices and high-capacity storages, many users have thousands of media files in their devices. In such a situation, it is difficult and time consuming for a user to find a file or song.

Furthermore, though several ID3 tags (e.g., a singer, genre, title, and play time) are provided for each music file, navigating through these text-based tags is difficult not only in a small display panel such as those of mobile devices, but also in a music player of a personal computer. Moreover, a user must listen to each song in order to check the song, which is an inconvenient process.

Korean Unexamined Patent 2006-053793 (Apparatus and Method for Controlling Title List Display) discloses a technology in which genre information corresponding to a title is read, a unique icon is generated using the information, and the generated icon is displayed as a title list along with a reduced image representing the title. However, the same icon is provided for the same genre. Hence, this disclosure does not include a technology that shows characteristics for each music file.

### SUMMARY OF THE INVENTION

Aspects of the present invention extract characteristics of a music file, and generate and provide animation corresponding to the music file based on the extracted characteristics.

In accordance with an example embodiment of the present invention, there is provided an apparatus for managing a music file including a music-file-characteristic-extracting device and a music file play device. Such an apparatus comprises: an information-extracting unit that extracts basic information from a predetermined music file; a characteristic-checking unit that checks characteristics on the music file; a table-generation unit that generates a table including the extracted basic information and the checked characteristics; and a communication unit that transmits the generated table to the music file play device.

In accordance with another example embodiment of the present invention, there is provided an apparatus for managing a music file including a music-file-characteristic-extracting device and a music file play device. Such an apparatus comprises: a communication unit that receives a table including basic information and characteristics, transmitted from the music-file-characteristic-extracting device; an information-extracting unit that extracts basic information from the music file; and an animation-generation unit that generates the animation of the music file based on the characteristics of the music file by checking characteristics corresponding to the extracted basic information in the transmitted table.

In accordance with yet another example embodiment of the present invention, there is provided a method of managing a music file using a music-file-characteristic-extracting device. Such a method comprises: extracting basic information from a predetermined music file; checking characteristics of the music file; and generating a table including the extracted basic information and the checked characteristics.

In accordance with still another embodiment of the present invention, there is provided a method of managing a music file using a music file play device. Such a method comprises: receiving a table including basic information and characteristics of the music file, transmitted from a music-file-characteristic-extracting device; extracting basic information from the music file; and generating an animation of the music file based on the characteristics by checking the characteristics corresponding to the extracted basic information in the transmitted table.

In accordance with another embodiment of the present invention, there is provided an apparatus for generating an animation corresponding to a music file. Such an apparatus comprises: a characteristic-checking unit to check characteristics of a music file; and an animation-generation unit to generate an animation corresponding to the music file and based on the checked characteristics.

In accordance with yet another embodiment of the present invention, there is provided a method of generating an animation corresponding to a music file. Such a method comprises: checking characteristics of a music file; and generating an animation corresponding to the music file and based on the checked characteristics.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram illustrating an apparatus for checking music file characteristics according to an example embodiment of the present invention;

FIG. 2 is a block diagram illustrating a music file play device according to an example embodiment of the present invention;

FIGS. 3A and 3B illustrate characteristics of a music file, checked by an apparatus for checking music file characteristics, and animation elements corresponding to the characteristics according to an example embodiment of the present invention;

FIGS. 4A and 4B illustrate a table generated by a table-generating unit of an apparatus for checking music file characteristics according to an example embodiment of the present invention;

FIGS. 5A through 5D illustrate animation corresponding to a music file generated by an animation-generation unit of a music file play device according to an example embodiment of the present invention;

FIG. 6 is a flowchart illustrating a process of checking music file characteristics and generating a table in a method of managing a music file according to an example embodiment of the present invention;

FIG. 7 is a flowchart illustrating a process of generating animation corresponding to a music file in a method of managing the music file according to an example embodiment of the present invention; and

FIG. 8 illustrates an apparatus for managing a music file according to an example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

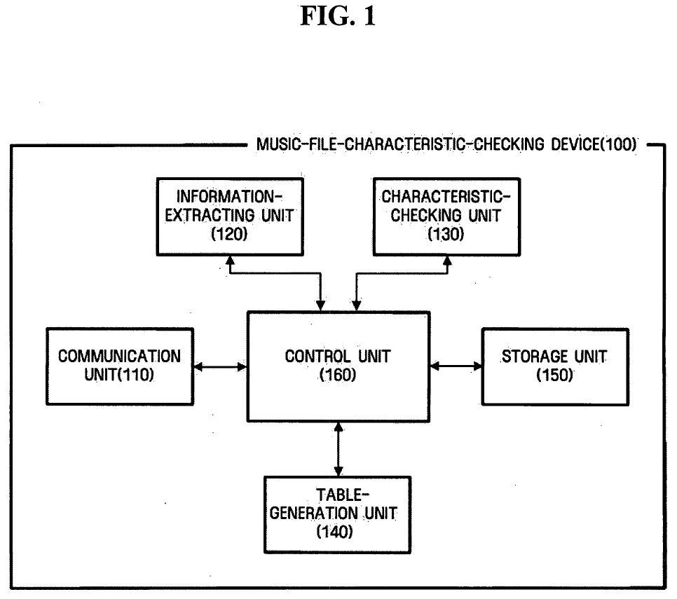

FIG. 1 is a block diagram illustrating an apparatus for checking music file characteristics according to an example embodiment of the present invention. According to aspects of the present invention, an apparatus for managing a music file includes a device for checking characteristics of a music file (i.e., a music file characteristic checking device), and a device for generating animation corresponding to the music file based on the characteristics (i.e., a music file play device). The music file characteristic checking device and the music file play device may, although not necessarily, be implemented as a single device or as separate devices.

Referring to FIG. 1, a music file characteristic checking device 100 includes a communication unit 110, an information-extracting unit 120, a characteristic-checking unit 130, a table-generation unit 140, a storage unit 150, and a control unit 160.

The term unit, as used herein, refers to, but is not limited to, a software or hardware component, such as a Field Programmable Gate Array (FPGA) or an Application Specific Integrated Circuit (ASIC), that performs certain tasks. A unit may advantageously be configured to reside in an addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units.

The information-extracting unit 120 extracts basic information from a predetermined music file. Here, the basic information can be extracted from an ID3 tag of a music file, and the ID3 tag can include data related to audio data (such as a title, a music ID, an artist, an album, a composition year, a genre, and a comment).

The characteristic-checking unit 130 checks characteristics of the music file. Here, the characteristics may include one or more of pitch, harmonics, loudness, tempo, timbre, and rhythm. Furthermore, the characteristic-checking unit 130 can determine which category each of the characteristics belongs to from among categories of characteristics based on a critical range of characteristics of the music file. Here, the characteristic-checking unit 130 checks characteristics of a predetermined section of a music file, and the checked characteristics are used when generating an animation corresponding to the music file. The predetermined section may be one or more of a refrain section, a climax section, and a section arbitrarily selected by a user.

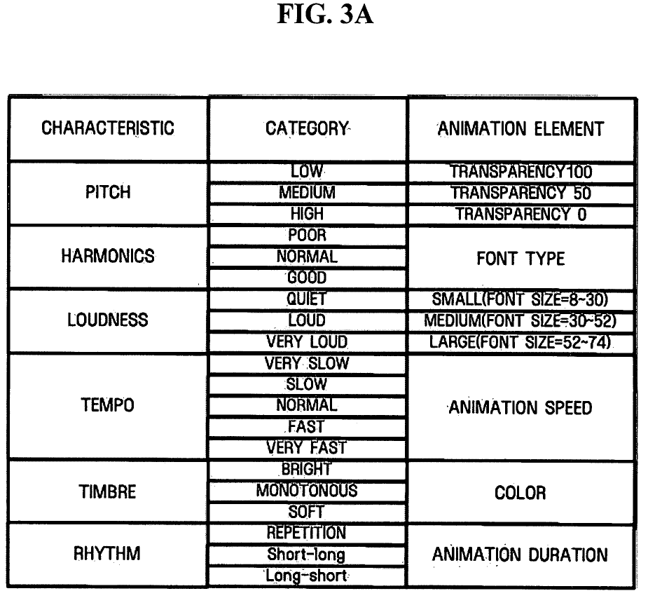

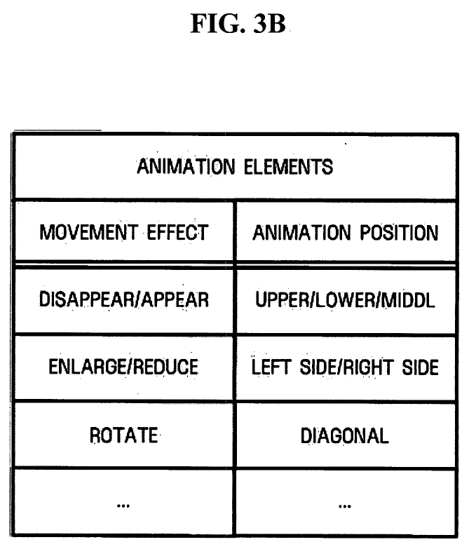

Moreover, the characteristic-checking unit 130 checks whether there is a section where characteristics change while the music file is played (i.e., reproduced). Here, the characteristics of the changed section can be used to change the animation corresponding to the music file. The characteristics of a music file and the animation elements thereof are described in more detail with reference to FIGS. 3A and 3B.

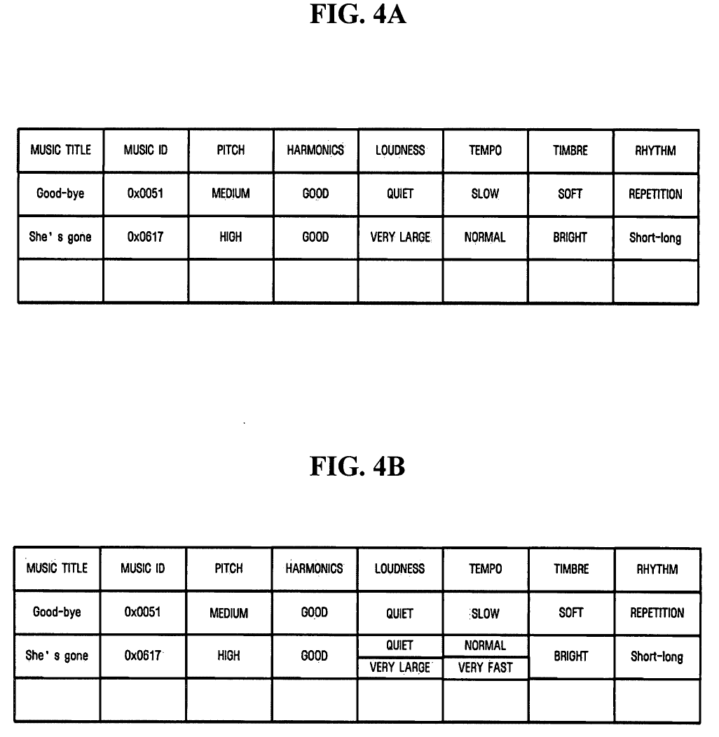

The table-generation unit 140 generates a table where the basic information of the music file extracted by the information-extracting information 230 is mapped to each animation element. For example, if the information-extracting unit 120 extracts basic information on song A and the characteristic-checking unit 130 checks characteristics on song A, the table-generation unit 140 generates a table where the extracted and checked information and animation elements are mapped in a 1:1 manner. However, it is understood that, according to other aspects, the table may be generated to not include the animation elements, such that a music file play device receives the characteristic information and maps the characteristics to the animation elements. A table including basic information and characteristics will be described in more detail with reference to FIGS. 4A and 4B.

The storage unit 150 stores the music file and the generated table including the basic information and the characteristics.

The communication unit 110 communicates with a music file play device 200, and transmits the table and music files stored in the storage unit 150.

The control unit 160 controls an operation of the communication unit 110, the information extracting unit 120, the characteristic-checking unit 130, the table-generation unit 140, and the storage unit 150.

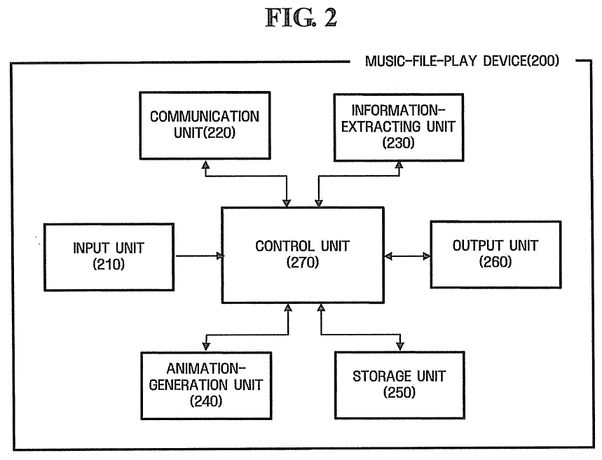

FIG. 2 is a block diagram illustrating a music file play device 200 according to an example embodiment of the present invention. Referring to FIG. 2, the music file play device 200 includes an input unit 210, a communication unit 220, an information-extracting unit 230, an animation-generation unit 240, a storage unit 250, an output unit 260, and a control unit 270.

The input unit 210 receives a command signal input by a user. Here, the command signal may be, for example, a play list request signal of a music file or an operation control signal of the music file play device 200 (e.g., a play, stop, fast forward, and rewind of a music file).

The communication unit 220 communicates with a music file characteristic checking device 100 (as illustrated in FIG. 1), and receives a table including basic information, characteristics, and music files.

The information-extracting unit 220 extracts basic information from a music file. Here, the basic information can be extracted from the ID3 tag of the music file, and the ID3 tag can include data related to audio data (such as a title, a music ID, an artist, an album, a composition year, a genre, and a comment).

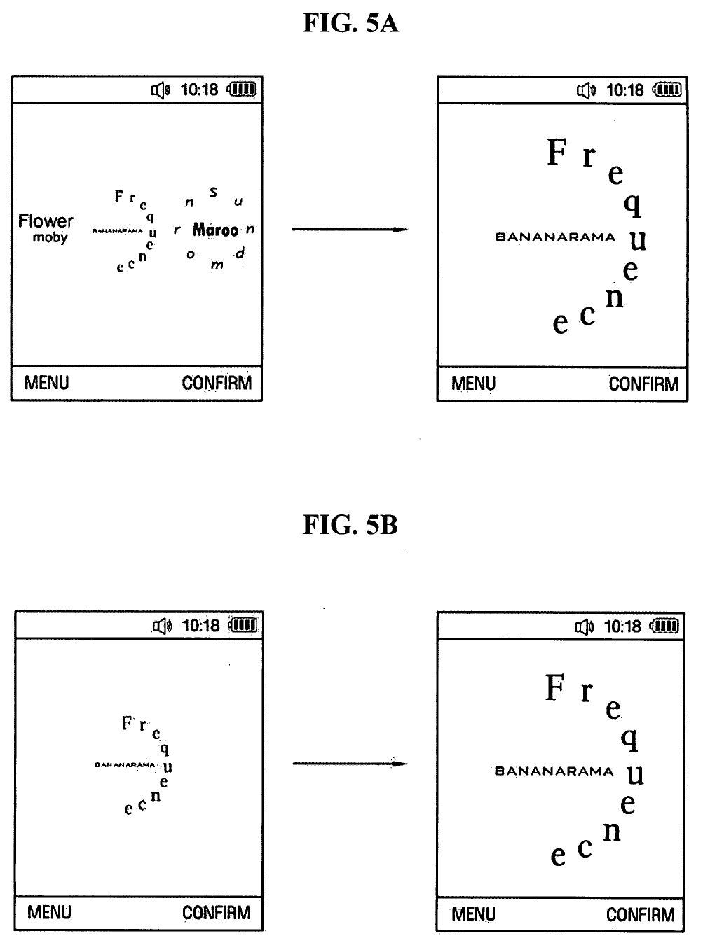

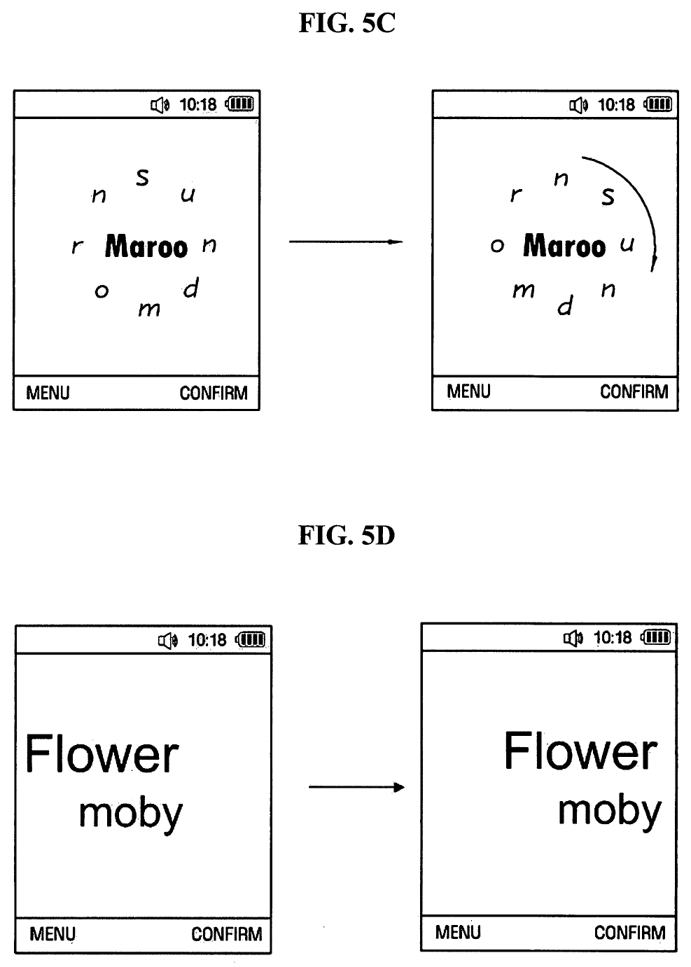

The animation-generation unit 240 generates an animation corresponding to the music file based on information within the table transmitted through the communication unit 220. Here, the animation refers to the state where basic information of the music file is presented with dynamic movement. The animation-generation unit 240, for example, may provide the title of the music file and the artist information as animation. However, other information from among the basic information of the music file can be provided as animation. Different animations are generated for each music file, and the animation corresponding to the music file has dynamic movements visible on a display panel. For example, in the case where song A is played (i.e., reproduced) by a user, the information-extracting unit 230 extracts the title of the song and the ID, and the animation-generation unit 240 retrieves the extracted title and the ID by referring to the table stored in the storage unit 250. Then, the animation corresponding to the music file is generated based on the category of the retrieved characteristics. The animation corresponding to the music file will be described in more detail with reference to FIGS. 5A and 5B.

The storage unit 250 stores the music files and the table including the basic information and characteristics transmitted via the communication unit 220.

The output unit 260 outputs the animation corresponding to the music file generated by the animation-generation unit 240.

The control unit 270 determines command signals generated by the user, and checks a termination of the music file reproduction. Furthermore, the control unit 270 controls an operation of the input unit 210, the communication unit 220, the information-extracting unit 230, the animation-generation unit 240, the storage unit 250, and the output unit 260.

FIGS. 3A and 3B illustrate characteristics of a music file, checked by an apparatus for checking music file characteristics, and animation elements corresponding to the characteristics according to an example embodiment of the present invention.

Referring to FIG. 3A, the characteristics of a music file are a pitch, harmonics, loudness, a tempo, a timbre, and rhythm. However, it is understood that according to other aspects, a different combination of some or none of these characteristics may be checked, and/or other characteristics of the music file may be checked. Each of the characteristics is divided into a plurality of categories. For example, the pitch is categorized into low, medium, and high; the harmonics is categorized into poor, normal, and good; the loudness is categorized into quiet, loud, and very loud; the tempo is categorized into very slow, slow, medium, fast, and very fast; the timbre is categorized into bright, monotonous, and soft; and the rhythm is categorized into repetition, short-long, and long-short. It is understood that these categorizations are examples and can be implemented in other ways or other categorizations may be used.

As described above with reference to FIG. 1, the characteristic-checking unit 130 of the music file characteristic checking device 100 checks categories on characteristics of the music file based on a predetermined critical range. For example, the critical range of 10 to 30 of the pitch elements belongs to the “low” category, the critical range of 30 to 60 belongs to the “medium” category, and the critical range of greater than 60 belongs to the “high” category. As such, the characteristic-checking unit 130 can recognize the category of the pitch of song A by checking the critical range of the pitch elements of song A.

Furthermore, animation elements include the transparency, font type, font size, movement speed, color, and duration. For example, the transparency is applied to the pitch, the font type to the harmonics, the font size to the loudness, the movement speed to the tempo, the color to the timbre, and the duration to the rhythm. Here, the color can be changed depending on the user's selection. It is understood that these animation elements are mere examples, and can be implemented in other ways or other animation elements may be used according to other aspects of the present invention.

FIG. 3B illustrates the movement effects and the animation position information. The movement effects include an effect where the animation disappears and reappears, an effect where the animation is magnified and reduced, and an effect where the animation is rotated. The animation position includes upper, lower and middle, left and right, and diagonal. Here, the movement effects and the animation position may be applied to the animation of the music file according to a user's arbitrary selection, regardless of characteristics of the music file. That is, animation elements illustrated in FIG. 3A are necessarily included when generating the animation corresponding to a music file based on characteristics of the music file, and the animation effects and the animation position of FIG. 3B are randomly selected by a user and then additionally included when generating the animation corresponding to the music file.

For example, it is assumed that the pitch of song A is “high,” the harmonics are “normal,” the loudness is “quiet,” the tempo is “slow,” the timbre is “bright,” and the rhythm is “repetition.” Referring to FIG. 3A, the transparency of the animation of song A is 0, the font type is bold, the font size is small (e.g., font size: 15), the movement speed of the animation is slow, the color is blue, and the animation duration is 1 minute. Here, the elements of the animation effects and the animation position can be added to the animation of song A depending on the arbitrary selection of the user.

That is, the animation corresponding to song A is generated based on the table where characteristics of song A are mapped to animation elements. Additionally, an animation including movement effects (e.g., a rotation) and the animation position (e.g., the middle) can be generated by the user. However, it is understood that according to other aspects, the movement effects and/or the animation position may be applied according to the characteristics of the music file. Furthermore, it is understood that these described movement effects and animation positions are mere examples, and other movement effects and animation positions may be used.

FIGS. 4A and 4B illustrate a table generated by a table-generating unit of an apparatus for checking music file characteristics according to an example embodiment of the present invention.

FIG. 4A illustrates a case of extracting characteristics for a predetermined section of a music file. As illustrated, a table-generating unit 140 generates a table where the music title and the music ID information, among basic information of the music file extracted by an information-extracting unit 120, are mapped to animation elements according to the category of each of the characteristics (i.e., the pitch, harmonics, loudness, tempo, timbre, and rhythm) of a predetermined section of the music file. Here, the generated table is transmitted to a media file play unit 200, and an animation-generating unit 240 is used to generate the animation corresponding to a music file based on the table.

Next, while the music file is played (i.e., reproduced), if there are characteristics in the changed section, a table is additionally generated where animation elements are mapped according to the category of characteristics for the section where characteristics are changed. As such, a plurality of characteristics and animation elements are included in a music file.

Hence, as illustrated in FIG. 4B, if a table where there are a plurality of characteristics is transmitted to the media file play device 200, the animation-generating unit 240 generates an animation according to characteristics checked in an arbitrary section, and an animation according to the changed characteristics.

FIGS. 5A through 5D illustrate an animation of a music file generated by an animation-generation unit of a music file play device 200 according to an example embodiment of the present invention. Here, FIG. 5A illustrates a play list of music files displayed through the output unit 260 of the music file play device 200, and FIGS. 5B through 5D illustrate an animation corresponding to a music file.

As illustrated in FIG. 5A, when the play list of the user's music files is requested, animations corresponding to a plurality of music files are displayed on the display panel of the music file play device 200. Here, animations corresponding to the displayed music files are dynamically changed, and animations corresponding to each music file may have different movements. Then, if the user selects an animation corresponding to a certain music file from a play list of the displayed music file, the animation corresponding to the selected music file is magnified to fit the whole screen of the display panel. Here, the animation of the displayed music file is dynamically changed.

The reduction and magnification operation is repeated in the animation corresponding to the music file illustrated in FIG. 5B. Here, the animation effect (e.g., a rotation) can be added not only to the whole animation of the music file, but also to each of the characters.

The animation corresponding to the music file illustrated in FIG. 5C is rotated around a predetermined axis. Here, the animation effect (e.g., disappearance) can be added not only to the whole animation, but also to each of the characters.

The animation corresponding to the music file illustrated in FIG. 5D moves in right and left directions. Here, the animation effect (e.g., rotation) can be added not only to the whole animation, but also to each of the characters.

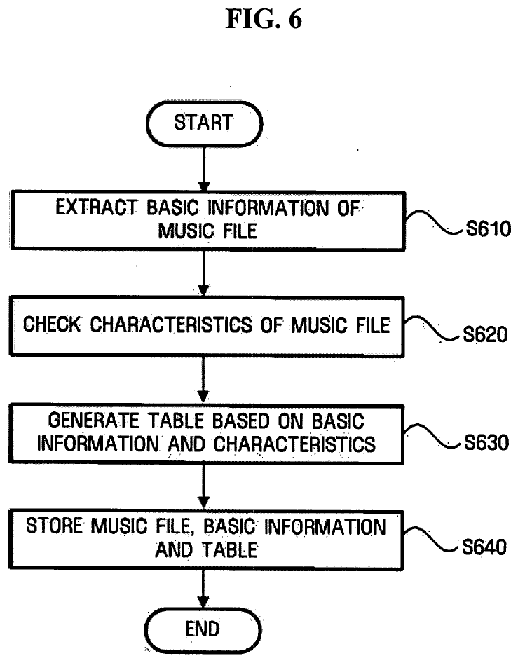

FIG. 6 is a flowchart illustrating a process of checking music file characteristics and generating a table in a method of managing a music file according to an example embodiment of the present invention.

First, the information-extracting unit 120 of the music file characteristic checking device 100 (illustrated in FIG. 1) extracts basic information (e.g., a title, artist, genre, and music ID) of a predetermined music file based on the ID3 tag of the music file in operation S610.

Then, the characteristic-checking unit 130 checks characteristics of the music file from a predetermined section of the music file in operation S620. That is, the characteristic-checking unit 130 checks to which category the music file belongs among categories of characteristics of the music file. Here, characteristics of the music file may refer to pitch, harmonics, loudness, tempo, timbre, and rhythm. Because the process of checking the characteristics of a music file was explained with reference to FIGS. 3A and 3B, the description of the process is omitted here.

Then, in operation S630, the table-generation unit 140 generates a table where basic information of a music file extracted by the information-extracting unit 120 and characteristics of the music file checked by the characteristic-checking unit 130 are mapped to each of the animation elements. It is understood that, according to other aspects, the table may be generated to not include the animation elements, such that the music file play device 200 (illustrated in FIG. 2) receives the characteristic information and maps the characteristics to the animation elements. Here, because a process of generating a table was explained with reference to FIGS. 4A and 4B, the detailed description of the process is omitted here.

Then, in operation S640, the control unit 160 stores the table, which includes basic information and characteristics, and music files in the storage unit 150.

Furthermore, the characteristic-checking unit 130 checks whether there is a section of the music file where characteristics are changed while the music file is reproduced. As a result, in the case where there is a section where characteristics are changed, the changed characteristics are added to the table.

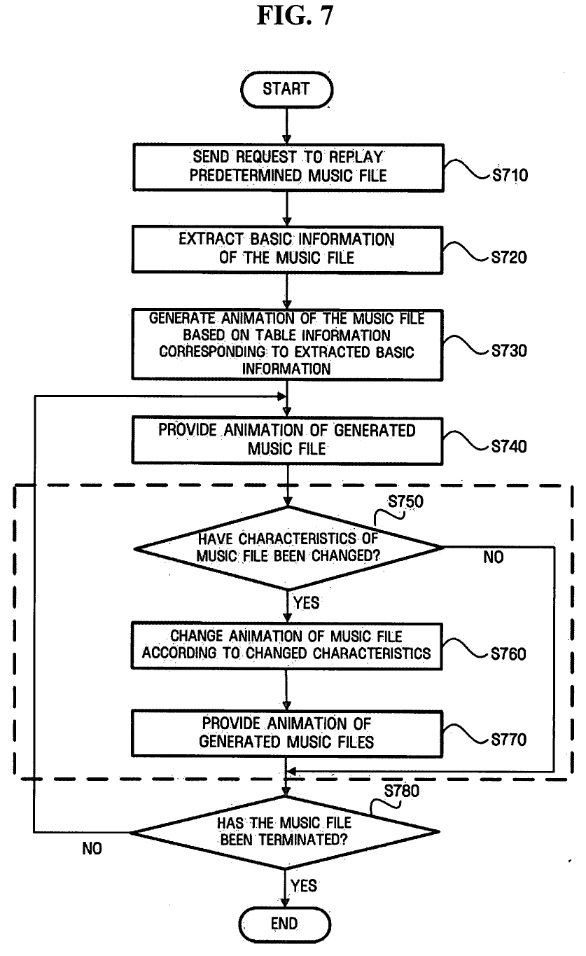

FIG. 7 is a flowchart illustrating a process of generating animation corresponding to a music file in a method of managing the music file according to an example embodiment of the present invention. Here, it is assumed that the music file play device 200 (illustrated in FIG. 2) receives a table including predetermined music files, basic information and characteristics transmitted from the music file characteristic checking device 100 (illustrated in FIG. 1), and stores the table in the storage unit 250.

First, the input unit 210 of the music file play device 200 receives an input of a play-request signal for a music file in operation S710, and the information-extracting unit 230 extracts basic information from the ID3 tag of the music file in operation S720.

Then, in operation S730, the animation-generation unit 240 generates the animation corresponding to the music file based on the table information corresponding to the basic information extracted by the information-extracting unit 230. Here, the title and artist information of the music file is generated as the animation of the music file, and a different animation is generated for each music file. Because the process of generating an animation was explained with reference to FIGS. 5A through 5D, the detailed description of the process is omitted here.

Then, in operation S740, the animation of the generated music file is provided to a display panel of the music file play device 200 through the output unit 260.

Further, in operation S750, it is determined whether characteristics of the music file change while the music file is reproduced. Here, whether the characteristics have been changed can be determined by checking whether there are a plurality of entries for one characteristic one of the music file within the table stored in the storage unit 250. In the case where the characteristics have not been changed, operation S780 is performed next. In the case where the characteristics do change, in operation S760, the animation-generation unit 240 changes the animation corresponding to the music file based on the new characteristics in the table information stored in the storage unit 250. However, it is understood that according to other aspects of the present invention, the changing of the animation (or storing of additional animations for a music file) may be omitted.

Then, in operation S770, the animation of the changed music file is provided to the display panel of the music file play device 200 through the output unit 260. Here, operations S750 through S780 can be omitted.

Next, the control unit 270 determines whether the reproduction of the music file has been terminated in operation S780. In the case where the reproduction has not been terminated, the animation of the music file is continually provided to the display panel.

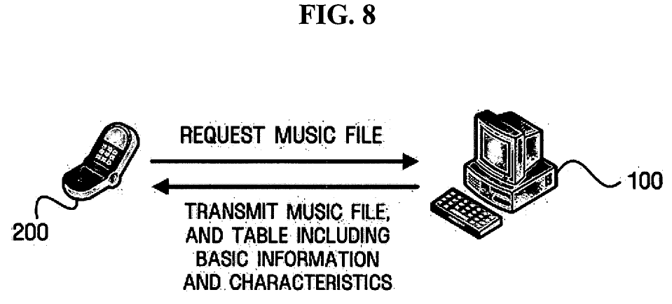

FIG. 8 illustrates an apparatus for managing a music file according to an example embodiment of the present invention. Referring to FIG. 8, the apparatus for managing a music file includes a music file characteristic checking device 100 and an animation generation device 200 for the music file based on the characteristics of the music file. Here, the music file characteristic checking device 100 may be a personal computer, and the animation generation device 200 may be an MP3 player or a mobile phone. Moreover, the animation generation device 200 can have the functions of a music file play device.

If the animation generation device 200 sends a request to download a music file to the music file checking device 100, the communication unit 110 of the music file characteristic checking device 100 receives the request from the animation generation device 200.

Then, the music file characteristic checking device 100 extracts basic information of the music file, checks characteristics of the music file, generates a table in which the basic information and characteristics are stored, and transmits the generated table and the music file to the animation generation device 200 through the communication unit 110.

As such, the animation generation device 200 generates the animation of the music file based on the information stored in the table corresponding to the basic information of the music file, and provides the generated animation to the display panel.

The method and apparatus according to aspects of the present invention has the following advantages. First, because characteristics are extracted from a music file and an animation corresponding to the music file is generated and provided based on the extracted characteristics, the music and the images are matched to provide an effective user interface. Second, because different animations are provided for each of the music files, the music files can be easily and intuitively retrieved.

Various components of the apparatuses as shown in FIGS. 1 and 2, such as the information-extracting unit 120 and the characteristic-checking unit 130, can be integrated into a single control unit, or alternatively, can be implemented in software or hardware, such as, for example, an application specific integrated circuit (ASIC). As such, it is intended that the processes described herein be broadly interpreted as being equivalently performed by software, hardware, or a combination thereof. Software modules can be written via a variety of software languages, including C, C++, Java, Visual Basic, and many others. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Instructions of the software routines or modules may also be loaded or transported into the wireless cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the checking of changed characteristics of the music file and generating of additional animations based thereon may be omitted according to aspects of the present invention. Furthermore, the table information may include the animation elements, or may just include the basic information and the characteristics such that an animation generating device or a music file play device maps animation elements to the characteristics and generations the animations. Accordingly, it is intended, therefore, that the present invention not be limited to the various example embodiments disclosed, but that the present invention includes all embodiments falling within the scope of the appended claims.

What is claimed is:

1. An apparatus for extracting characteristics of a music file in order for an animation generating device to create a unique animation corresponding to the music file based on the characteristics, the apparatus comprising:
an information-extracting unit to extract basic information from a music file;
a characteristic-checking unit to check characteristics of the music file;
a table-generation unit to generate a table including the extracted basic information and the checked characteristics; and
a communication unit to transmit the generated table to the animation generating device so that the animation generating device can check the characteristics of the music file in the table and generate an animation based on the characteristics.

2. The apparatus as claimed in claim 1, wherein the checked characteristics of the music file include at least one of pitch, harmonics, loudness, tempo, timbre, and rhythm.

3. The apparatus as claimed in claim 1, wherein the characteristic-checking unit checks the characteristics of a section of the music file.

4. The apparatus as claimed in claim 3, wherein:
the characteristic-checking unit determines a category of each of the checked characteristics, and
the table-generation unit generates the table to include the determined category of each of the checked characteristics.

5. The apparatus as claimed in claim 4, wherein:
the characteristic-checking unit checks whether there is another section having different characteristics than the checked characteristics of the section of the music file while the music file is reproduced, and
the table-generation unit generates the table to include the determined category of each of the checked characteristics of the section of the music file and a determined category of each of the different characteristics of the other section.

6. The apparatus as claimed in claim 1, wherein the table-generation unit generates the table to include the extracted basic information, the checked characteristics, and animation elements, such that the checked characteristics are mapped to the animation elements in a 1:1 ratio.

7. The apparatus as claimed in claim 1, wherein the communication unit transmits the music file to the animation generating device.

8. An apparatus for generating an animation corresponding to a music file based on characteristics of the music file extracted by a music file characteristic extracting device, the apparatus comprising:
a communication unit to receive a table including basic information and characteristics of a music file, transmitted from the music file characteristic extracting device;
an information-extracting unit to extract basic information from the music file; and
an animation-generation unit to generate an animation corresponding to the music file and based on the characteristics by checking the characteristics of the music file corresponding to the extracted basic information in the transmitted table.

9. The apparatus as claimed in claim 8, wherein the animation-generation unit generates a unique animation for each music file.

10. The apparatus as claimed in claim 8, wherein, if the music file comprises a first section having first characteristics and a second section having second characteristics, the animation-generation unit generates the animation corresponding to the music file to have a first animation based on the first characteristics of the music file and a second animation based on the second characteristics of the music file.

11. The apparatus as claimed in claim 8, wherein the animation-generation unit generates the animation on information from among the basic information included in the transmitted table.

12. The apparatus as claimed in claim 11, wherein the information is a title and an artist of the music file.

13. The apparatus as claimed in claim 8, wherein the generated animation has a dynamic movement.

14. The apparatus as claimed in claim 8, further comprising:
a storage unit to store the transmitted table.

15. The apparatus as claimed in claim 8, wherein a user can control movement effects and a position of the animation on a display device.

16. The apparatus as claimed in claim 8, wherein the animation-generation unit generates a first animation element of the animation based on a first characteristic of the characteristics, and a second animation element of the animation based on a second characteristic of the characteristics.

17. A method of extracting characteristics of a music file in order to generate a unique animation corresponding to the music file based on the characteristics, the method comprising:
extracting basic information from a music file;
checking characteristics of the music file; and
generating a table including the extracted basic information and the checked characteristics.

18. The method as claimed in claim 17, wherein the checked characteristics of the music file include at least one of pitch, harmonics, loudness, tempo, timbre, and rhythm.

19. The method as claimed in claim 17, wherein the checking of the characteristics comprises:
checking the characteristics of a section of the music file.

20. The method as claimed in claim 19, wherein:
the checking of the characteristics further comprises determining a category of each of the checked characteristics; and
the generating of the table comprises generating the table to include the determined category for each of the checked characteristics.

21. The method as claimed in claim 20, further comprising:
checking whether there is another section having different characteristics than the checked characteristics of the section of the music file while the music file is reproduced, wherein
the generating of the table to include the determined category comprises generating the table to include the determined category of each of the checked characteristics of the section of the music file and a determined category of each of the different characteristics of the other section.

22. The method as claimed in claim 17, wherein the generating of the table comprises generating the table to include the extracted basic information, the checked characteristics, and animation elements, such that the checked characteristics are mapped to the animation elements in a 1:1 ratio.

23. A method of generating an animation corresponding to a music file based on characteristics of the music file extracted by a music file characteristic extracting device, the method comprising:
receiving a table including basic information and characteristics of a music file;
extracting basic information from the music file; and
generating an animation corresponding to the music file and based on the characteristics by checking the characteristics of the music file corresponding to the extracted basic information in the received table.

24. The method as claimed in claim 23, wherein a unique animation is generated for each music file.

25. The method as claimed in claim 23, wherein the generating of the animation comprises generating the animation corresponding to the music file to have a first animation based on the first characteristics of the music file and a second animation based on the second characteristics of the music file if the music file comprises a first section having first characteristics and a second section having second characteristics.

26. The method as claimed in claim 23, wherein the generating of the animation comprises generating the animation on information from among the basic information included in the received table.

27. The method as claimed in claim 23, wherein the generated animation has a dynamic movement.

28. The method as claimed in claim 23, wherein the generating of the animation comprises:
generating a first animation element of the animation based on a first characteristic of the characteristics; and
generating a second animation element of the animation based on a second characteristic of the characteristics.

29. An apparatus for generating an animation corresponding to a music file, the apparatus comprising:
a characteristic-checking unit to check characteristics of a music file; and
an animation-generation unit to generate an animation corresponding to the music file and based on the checked characteristics.

30. The apparatus as claimed in claim 29, wherein the checked characteristics of the music file include at least one of pitch, harmonics, loudness, tempo, timbre, and rhythm.

31. The apparatus as claimed in claim 29, further comprising:
an information-extracting unit to extract basic information from the music file.

32. The apparatus as claimed in claim 31, further comprising:
a table-generation unit to generate a table including the extracted basic information and the checked characteristics.

33. The apparatus as claimed in claim 32, wherein:
the characteristic-checking unit checks the characteristics of a section of the music file and determines a category of each of the checked characteristics, and
the table-generation unit generates the table to include the determined category of each of the checked characteristics.

34. The apparatus as claimed in claim 33, wherein:
the characteristic-checking unit checks whether there is another section having different characteristics than the checked characteristics of the section of the music file, and
the table-generation unit generates the table to include the determined category of each of the checked characteristics of the section of the music file and a determined category of each of the different characteristics of the other section.

35. The apparatus as claimed in claim 34, wherein the animation-generation unit generates the animation corresponding to the music file to have a first animation based on the determined category of each of the checked characteristics of the section of the music file and a second animation based on the determined category of each of the different characteristics of the other section.

36. The apparatus as claimed in claim 32, wherein the table-generation unit generates the table to include the extracted basic information, the checked characteristics, and animation elements, such that the checked characteristics are mapped to the animation elements in a 1:1 ratio.

37. The apparatus as claimed in claim 32, wherein the animation-generation unit generates the animation corresponding to the music file and based on the characteristics by checking the characteristics of the music file corresponding to the basic information of the music file in the transmitted table.

38. The apparatus as claimed in claim 31, wherein the animation-generation unit generates the animation on information from among the extracted basic information.

39. The apparatus as claimed in claim 29, wherein the animation-generation unit generates a first animation element of the animation based on a first characteristic of the characteristics, and a second animation element of the animation based on a second characteristic of the characteristics.

40. A method of generating an animation corresponding to a music file, the method comprising:
checking characteristics of a music file; and
generating an animation corresponding to the music file and based on the checked characteristics.

41. The method as claimed in claim 40, further comprising:
extracting basic information from the music file.

42. The method as claimed in claim 41, wherein the generating of the animation comprises generating the animation on information from among the extracted basic information.

43. The method as claimed in claim 40, wherein the generating of the animation comprises:
generating a first animation element of the animation based on a first characteristic of the checked characteristics; and
generating a second animation element of the animation based on a second characteristic of the checked characteristics.
